(19) United States
(12) Patent Application Publication
(10) Pub. No.: US 2012/0282587 A1
(43) Pub. Date: Nov. 8, 2012

(54) SYSTEM AND METHOD FOR GENERATING AND IMPLEMENTING INDIVIDUALIZED EDUCATIONAL PRACTICE WORKSHEETS

(75) Inventors: Robert M. Lofthus, Webster, NY (US); Michael Robert Furst, Penfield, NY (US); Kristine A. German, Webster, NY (US); Sharath Srinivas, Webster, NY (US); Eric Scott Hamby, Webster, NY (US); Gary W. Skinner, Rochester, NY (US); Dusan G. Lysy, Fairport, NY (US)

(73) Assignee: XEROX CORPORATION, Norwalk, CT (US)

(21) Appl. No.: 13/101,620

(22) Filed: May 5, 2011

(51) Int. Cl. G09B 7/00

(52) U.S. Cl. 434/335

(57) ABSTRACT

A method and system generates and administers an individualized student worksheet. A set of problems and a unique embedded data pattern are generated and printed on a worksheet substrate. A teacher may point a camera pen point at an area of the pattern to identify the substrate and a location on the substrate. Based on this information, the method and system may access a worksheet file to identify the problem whose physical position corresponds to the captured embedded data. The system may present the problem's solution to the teacher, who may then use the pen to mark the problem as correct or incorrect, and optionally annotate notes for the student, teacher or others. The camera pen may collect the teacher's marks and annotations and store them with the worksheet file for later retrieval.

### CROSS-REFERENCE TO RELATED APPLICATIONS

This patent application is related to U.S. patent application Ser. No. 12/958,768, filed Dec. 2, 2010, the disclosure of which is incorporated herein by reference in its entirety.

This patent application also is related to U.S. patent application Ser. Nos. 12/339,979, 12/340,054, and 12/340,116, all filed on Dec. 19, 2008; U.S. patent application Ser. No. 12/054,824, filed Mar. 25, 2008; U.S. patent application Ser. No. 11/749,192, filed May 16, 2007; U.S. patent application Ser. No. 12/771,534, filed Apr. 30, 2010; and U.S. patent application Ser. No. 12/840,584, filed Jul. 21, 2010. The disclosures of all of the patent applications listed above are incorporated herein by reference.

### BACKGROUND

When an academic topic or skill is taught to students, the teacher may instruct the students and provide the students with practice worksheets to practice and reinforce the material. Typically, a single paper-based worksheet is duplicated for the entire class to use, even though the students may be progressing at different speeds. Advantages of the paper-based worksheet include that it can be quickly corrected and annotated by the teacher. Both the student and the teacher get immediate feedback and the student/teacher relationship is reinforced. Additionally, the paper worksheet is portable and durable. It can be brought home the same day for parents to view, and then saved, if desired.

A disadvantage of many current paper-based worksheets is that they are not tailored to the student's ability or progression in class. Although a teacher could go through the process of manually creating or selecting individual worksheets for each student, the selection process would be very time-consuming. In addition, the time and effort required for the teacher to review, grade and annotate each individual worksheet would be significant. Although attempts to provide individualized instruction and practice have been via a computer, the student/teacher relationship advantages of paper-based worksheets are lost in computer-based systems.

### SUMMARY

In an embodiment, a system for administering an individualized worksheet for a student may include a processor and a tangible, computer-readable memory. The memory may be programmed with instructions that, when executed, cause the processor to implement a method of administering an individualized worksheet for a student. The method may include accessing a problem library and selecting a set of problems to be printed in an individualized worksheet. The method may generate a unique set of embedded data that, when printed on a substrate, will yield a unique pattern. The pattern is configured to be read by an optical collection device. The method may generate a worksheet file for the individualized worksheet. The worksheet file will contain data corresponding to a worksheet template, the selected problems, a solution to each of the selected problems, and the embedded data so that the embedded data identifies a physical position of each selected problem on the individualized worksheet. The method will receive captured data from an optical input device. The captured data will include at least some of the embedded data for the individualized worksheet. The method may identify, from the worksheet file, a problem from the set of problems. The identified problem is that whose physical position corresponds to the position of the captured embedded data on the worksheet. The method may identify a solution corresponding to the identified problem, and it may generate a command to present the solution to a user of the individualized worksheet.

The system may include a data warehouse that stores a worksheet data repository, the problem library, and the worksheet files. It also may include a printing device configured to, upon receipt of the worksheet file, execute the file and print the individualized worksheet on a substrate. In addition, the optical collection device may be embodied in a camera pen that also includes a processor; a tangible, computer-readable memory; and a marking tip that can be placed on and moved across the worksheet under a force to impart a mark. The camera pen also may include an audio output and programming instructions stored on the memory that, when executed in connection with receipt of the command to present the solution to the user, cause the audio output to deliver the solution via the audio output in audible form.

In some embodiments, when selecting a set of problems for the worksheet, the method may include retrieving evaluation data corresponding to the student, retrieving data corresponding to a topic for the individualized worksheet, accessing the problem library to select a problem that corresponds to the topic and to the evaluation data, and including the selected problem in the set of problems. Generation of the worksheet file may include retrieving a worksheet template from a worksheet data repository and including the embedded data, the selected problem, a solution to the selected problem, and the worksheet template in the worksheet file.

In some embodiments the method also may include receiving a student response to the identified problem; receiving an annotation from user (such as a teacher) that corresponds to the student response; and storing data corresponding to the worksheet file, the student response, and the annotation in a data warehouse. The worksheet file data, the student response data, and the annotation data may be retrieved in a selective manner from the warehouse and displayed to the user.

Other features of the presently disclosed worksheet generator system and method will become apparent from the following detailed description, taken in conjunction with the accompanying drawings, which illustrate, by way of example, the presently disclosed worksheet generator system.

### BRIEF DESCRIPTION OF THE DRAWINGS

FIG. 1 is a schematic diagram of an exemplary academic worksheet generator system in accordance with the present disclosure.

FIG. 2 shows an exemplary practice worksheet generated in accordance with the present disclosure.

FIG. 3 shows a detailed block diagram of the exemplary components of a worksheet generator system such as that shown in FIG. 1.

FIG. 4 shows a flowchart of a method for generating academic worksheets in accordance with the present disclosure.

FIG. 5 illustrates an exemplary layered data structure for worksheet data.

FIG. 6 illustrates an alternate embodiment of an exemplary worksheet.

FIG. 7 shows additional detail for an example of a teacher evaluation area associated with an exemplary problem included in the worksheet shown in FIG. 6.

### DETAILED DESCRIPTION

This disclosure is not limited to the particular systems, devices and methods described, as these may vary. Also, the terminology used in this document is only for the purpose of describing particular versions or embodiments, and it is not intended to limit the scope. As used in the description below and in the appended claims, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” means “including, but not limited to.”

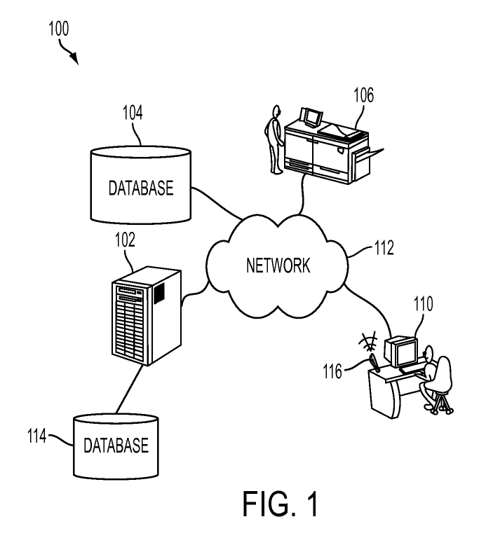

With initial reference to FIG. 1, an exemplary academic worksheet generator system in accordance with the present disclosure is illustrated and is designated generally as worksheet generator system 100. Worksheet generator system 100 includes a server 102, one or more data storage facilities 104, 114, at least one printing device 106, and one or more workstations 110. The system also may include one or more optical information collection devices such as a pen 116 that also contains an optical input device, such as a camera, that is capable of capturing images. An exemplary camera pen is disclosed in U.S. Pat. No. 6,208,771, the disclosure of which is incorporated herein by reference in its entirety. The camera pen may include a wireless or wired transceiver that enables it to engage in data communication with a workstation 110, and/or with other devices in the system.

Each of the components of worksheet generator system 100 is in data communication with at least one of the other components, either directly (such as via a direct cable connection) or through via one or more networks 112. For example, as shown in FIG. 1 an exemplary data storage facility 104, a data storage facility 104 may communicate with the server via the network. Alternatively, a data storage facility may communicate directly with the server 102 as illustrated by exemplary data storage facility 114. In the latter situation, the server 102 may relay information from the data storage facility 114 out through the network 112, and the server 102 may receive information via the network 112 and relay the information to the data storage facility 114 for storage.

The server 102 is an electronic processing device that implements computer-readable program instructions and delivers data to other devices that are connected to the server, either directly or indirectly over a network. The server 102 may include a web server, a server, a minicomputer, a mainframe computer, a personal computer, a mobile computing device, or other such device. The server 102 receives student information, such as evaluation data associated with at least one previous academic practice worksheet completed by a student, and the server uses that evaluation data to generate a new academic practice worksheet for the student. The server 102 also may generate the worksheet based on characteristics of the student, including granular assessment data (described in U.S. patent application Ser. Nos. 12/339,979, 12/340,054, 12/340,116) related to the student's past academic performance, the student's likes and preferences (as described further below), the student's risk ratio (as described further below), and other features that the person who requests a worksheet can select.

The data storage facility 104 is a collection of one or more electronic devices having tangible computer-readable memory that stores data in a structured format, such as one or more databases, tables, or other computer-readable files. The printer 106 is an electronic device that is capable of printing text and/or graphics on a substrate such as paper. In some embodiments, the printer 106 may be a multifunction device (MFD) that incorporates the functionality of not only a printer, but also that of one or more other document processing devices such as a photocopier, scanner, fax machine, email device, or other device. The printer may include various components that are integrated and housed in a single housing, or it may include separate components which are interfaced to one another. The printer 106 includes any apparatus or system, such as a digital copier, xerographic printing system, ink jet printing system, reprographic printing system, bookmaking machine, or facsimile machine, which performs a document marking output function for any purpose. The modality for marking may include, for example, applying toner, ink, dye, or other marking material, to a substrate. The substrate may be a material such as paper, cardboard, a transparency, a paper derivative, or other method on which the marking material may be printed. The network 112 may be the Internet, an intranet, an ethernet, a local area network, a wide area network, or other means for providing data communication between a plurality of digital devices. Some of the data communication between any of the components of the worksheet generator system 100 may be via a direct connection which may be wired or wireless. In the examples described below, the network 112 is the Internet.

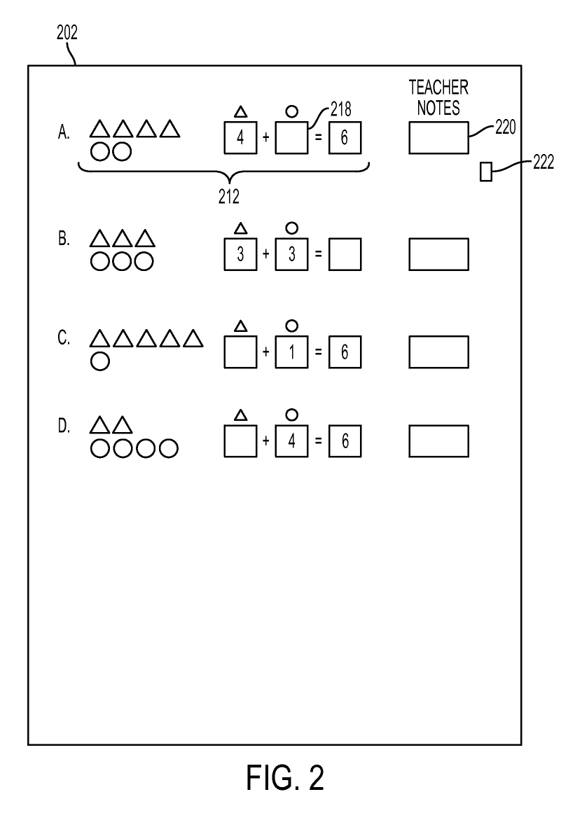

The term “academic practice worksheet” (also referred to as “worksheet” or “practice worksheet”) here includes at least one substrate, such as paper, that has at least one problem printed on it. An exemplary worksheet 202 having a plurality of problems 212 is shown in FIG. 2. The term “problem” refers to a question or other prompt to which a student is to provide or select a response, such as answer. Each problem 212 is designed to test the student's knowledge or progress with respect to an academic skill related to an academic topic, e.g., by performing a task related to at least one of addition, division, reading comprehension, spelling, grammar, etc. Each problem 212 is targeted to exercise one or more specific academic skills at a level in accordance with the student's progress through a progression, and at a specific difficulty level. The problems 212 may be presented to the student in a variety of ways and may prompt the student to provide a response in a variety of ways. For example, the student may be prompted to mark a response by circling a correct answer, matching items from two columns, filling in a blank, adding punctuation marks to a text sample, etc.

In the example of FIG. 2, a problem 212 prompts the student to enter a number in a response area 218. The worksheet 202 also may include a teacher annotation area 220 for individual problems, for a specified section of the worksheet, and/or for the entire worksheet. As used in this document, a “teacher” refers to any person who administers a worksheet to a student by reviewing and annotating a completed worksheet. For example, a worksheet may be administered in a classroom environment by the teacher, teacher's aide, parent volunteer, or other evaluator. Alternatively, a student may self-initiate a request for a worksheet and present the worksheet to a parent, teacher, student aide, or other evaluator for review and evaluation. In each case, the evaluator will be referred to herein as a “teacher.”

The teacher may use the annotation area and/or other areas of the worksheet to mark the problem as correct or incorrect. The teacher also may use the annotation area to mark any notes that the teacher wishes to communicate to the student, such as an annotation that explains why the answer is incorrect. The annotation area may be a box, circle or other shape in which the teacher may enter free text or select any of multiple predetermined optional annotations. Each of the annotation areas may be associated with one or more problems, with a section of the worksheet, or with the entire worksheet.

As will be described in more detail below, in various embodiments the worksheet is printed on a substrate on which embedded digital data is also printed, and the teacher uses an electronic input device such as a smart pen to evaluate and annotate the student's answers on the substrate. In embodiments described below that use camera pens or other smart pens, an annotation area (such as 220 in FIG. 2) may be used to trigger an annotation that is related to the student's response to the problem. The teacher may use the smart pen to enter the annotation, and the annotation will be saved in a data warehouse with an indication that identifies it as a teacher annotation. When the teacher touches the annotation area 220 with the smart pen, the annotation area may turn on and accept annotations. When the teacher touches another area or a predetermined “no annotation” area 222, the annotation area may turn off so that it no longer accepts additional annotations.

Referring again to FIG. 1, in order to provide a worksheet for a student, the server 102 generates a computer-readable file containing data and/or program instructions that cause the printer 106 to print a worksheet for a student. The server 102 may transmit the worksheet file directly to the printer 106 via the network 112. Alternatively, the processor may transmit the worksheet file to the teacher's or student's workstation 110, which may be a personal computer, laptop computer, tablet, personal digital assistant, smart phone, or other device capable of receiving message files. In the latter situation, a user of the system may then forward or otherwise cause the printer 106 to receive the file and print the worksheet.

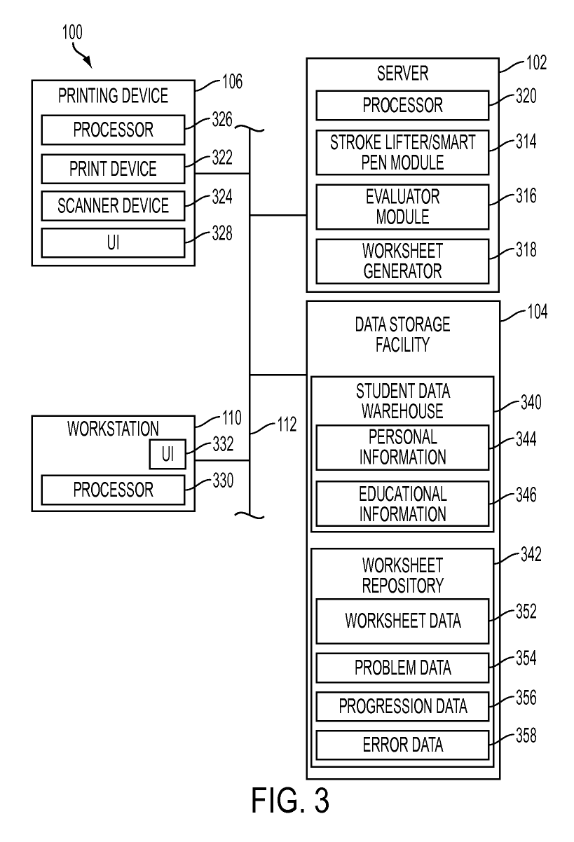

Referring to FIG. 3, the server 102 may generate the worksheet file via a worksheet generator module 318, which is a set of computer-readable instructions that cause the processor to generate a worksheet file. The worksheet file will contain data for one or more problems that will be printed on the worksheet. The problems may be selected from a worksheet repository 342, which is a data set housed in one or more of the data storage facilities 104 that includes worksheet data 352, problem data 354, progression data 356, and error data 358. The worksheet data 352 includes general information about the worksheet, such as a template for layout of the worksheet, header information, and topics to be covered in the worksheet (such as a particular subject within the field of math, science, etc.). The worksheet data 352 may include data that the processor can use to identify a candidate set of problems from a problem data set 354. The problem data set 354 is a library of candidate problems. For example, if the worksheet data indicates that the worksheet is for math and the topic to be covered in the worksheet is factoring polynomials, then the processor may use that data to select from the problem library 354 a candidate set of problems related to the topic. Any method of correlating the data points may be used, such as the use of data codes, fields in a relational database, or other selection methods. The problem data set 354 also may include solutions for each problem, although the solutions may not be printed on the actual worksheet.

Any worksheet that is generated for a student for a subject area may include one or more problems that are common to all students. Alternatively or in addition, the worksheet for the student may include one or more problems that are individualized to the student. To select individualized problems for inclusion in the worksheet, the system may access a student data warehouse 340 within one or more of the data storage facilities. The student data warehouse 340 is a data set that includes personal information 344 about the students and educational information 346 about the students. Personal information 344 may include, for example, a student name and/or identification code. The personal information 344 also may include information about the student's progression through a subject area, the student's correct (or incorrect) answer rate on previous worksheets in various subject areas, or other topics. The educational information 346 also may contain information about the student's progression through a subject area and correct (or incorrect) answer rates, or it may contain such information about other students who are in the student's class, grade level, or in a benchmark group.

The server may use this student data information, along with data from the worksheet repository 342, to generate a worksheet that includes problems that have been selected for the student. An exemplary problem selection process, and an explanation of how the system may update the student data warehouse and use the updated data for the generation of additional personalized worksheets, has been disclosed in U.S. patent application Ser. No. 12/958,768 and is described in more detail below. The set of problems may be individualized for each student in the teacher's group unit, such as class or grade level. Alternatively, students having evaluation criteria falling within a particular range may be clustered together such that one “individualized” worksheet problem set is generated for each cluster.

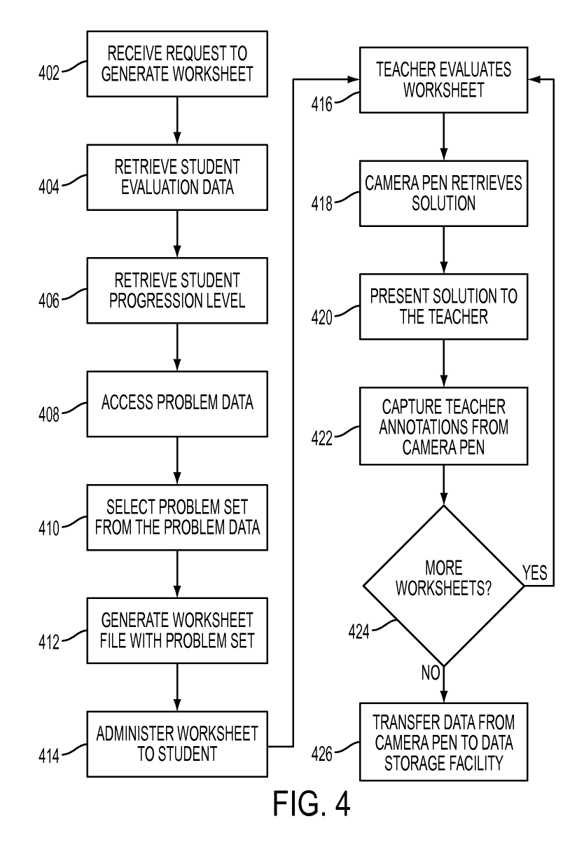

As illustrated in FIG. 4, in an embodiment of a worksheet generation process the server may receive a request to generate a practice worksheet for a particular student 402. The request may be initiated by a teacher, by the student, by another individual, or by an automated prompt. The server may then access the student data warehouse and retrieve evaluation data for the student 404. The evaluation data may include the personal information and educational information as described above, and if requested the data may be limited to that which satisfies certain criteria, such as a topic of study (math, science, etc.), a date range (such as the past 30 days) or other criteria. The evaluation data also may include a progression level of the student 406 to determine a level in which the student has progressed through a topic of study. The progression level may be based on various factors, such as whether the student demonstrated proficiency in previous worksheets, data entered into the data warehouse by the teacher, or other factors. The server may use any or all of this information to access the problem data 408 and select a set of problems 410 for the student that are appropriate for the student based on the student's evaluation data.

The system may then generate a printer-ready worksheet file 412 for the student that includes the selected problem set. The worksheet file may be stored in the worksheet repository, student data warehouse, or another data storage facility.

The worksheet file also may include a set of instructions to imprint embedded data on the worksheet. The embedded data will be a digitally-readable pattern or series of codes that uniquely identify the document and various locations on the document. The embedded data will contain elements that are unique to each worksheet, and the data will vary throughout different locations on each worksheet. For example, the embedded data that is printed on an area corresponding to a worksheet's problem #1 will be different from that printed on the area corresponding to the worksheet's problem #2.

The embedded data be any printable or printed, machine-readable indicia that may be used to identify a document and a location on the document. For example, the data may take the form of a unique, skewed dot matrix pattern. Instead of a pure matrix pattern, in which under typical circumstances each dot be printed at the point where the horizontal and vertical guide lines of the matrix intersect, each dot would be slightly set-off or “skewed” from its intersection. Such dot matrix patterns may be generated using technologies such as those available from Anoto, Inc. (See, e.g., “Introduction to the Livescribe Platform,” published Dec. 20, 2010 by Livescribe, Inc.) A smart pen such as those available from Livescribe, Inc. may be used to read the pattern. Alternatively, the embedded data may include a series of glyph codes or other codes, such as glyph codes that are generated using the process of U.S. Pat. No. 6,208,771, the disclosure of which is incorporated herein by reference in its entirety.

A worksheet is administered to the student by providing the student with a copy of the printed worksheet. The student completes the worksheet, including marking the worksheet with strokes (e.g., hand drawn strokes using a writing instrument, such as a pencil, crayon or pen) that indicate responses to each of the problems provided by the worksheet. Typically, there are indicators to the student, explicit or implied, that instruct the student where and how to mark a stroke when responding to a problem. For example, as shown in FIG. 2, the worksheet may include a response area 218 for each problem 216 to help guide the student as to where the student should mark his or her response.

When a worksheet is administered in a classroom environment, the person administering the worksheet can observe the students as they complete their respective worksheets. Thus, the classroom operates in accordance with conventional classroom protocol, and the teacher can gain insights into each student's abilities, progress, and struggles by observing them as they work. When the teacher observes that a student has completed a worksheet, or if time for completion has expired, the teacher may collect the worksheet, evaluate the student's work, and mark the worksheet with evaluation marks. The worksheet 202 and its problems 212 and response areas 218 are formatted and laid out in a manner so that it is straightforward for the teacher to observe how the student answered the problems and to evaluate the responses.

Referring again to FIG. 4, when the student completes a worksheet, the student, teacher, or another person or device may use a camera, scanner or multifunction device to scan or gather an image of the completed worksheet 414. Alternatively, the student's responses may be collected by other means, such as by uploading response data from a smart pen device if the student used such a device to complete the worksheet. The image file may be stored in the student data warehouse or another location. When an appropriate input device scans or otherwise reads the embedded data on an area of the document, the embedded data can be used to identify the worksheet and the location on the worksheet that the input device is reading. This information can then be used to access the worksheet repository (or another data storage facility) to identify the problem and retrieve the appropriate solution for the problem.

The system may present the solution for each problem to the teacher when the teacher is correcting the document. To accomplish this, the teacher uses a camera pen to evaluate the worksheet. The camera pen is a writing instrument that is also capable of reading the embedded data from the substrate, as described in the discussion of FIG. 1 above. As the teacher moves the pen over a problem, the camera pen gathers the embedded data in the area of the problem and uses the embedded data to identify the worksheet and positional coordinates, identifies the problem that is printed at the location, and retrieves the solution 418. In some embodiments, the smart pen may transmit the gathered positional data to a workstation or other receiver, which then requests the server to use the data to retrieve the problem and solution from the worksheet repository. In alternate embodiments where the camera pen itself has sufficient processing and storage capacity, some or all of the worksheet file may be transmitted to the pen. The pen's processor may then compare the embedded data with the worksheet file data to identify answers that correspond to the problems that are printed on the identified locations of the worksheet.

The solution is presented 420 to the teacher in any of various formats. If the smart pen has an audio output and the answer is available in an audio file, or if the smart pen includes text-to-speech capability, the smart pen may “speak” the answer by playing the audio file or converted speech through the audio output, such as through a speaker. Alternatively, the audio output may be a communications port or transmitter that sends a signal to another device to play the audio file or converted speech, such as through headphones or to a wireless data communication device such as a Bluetooth device. Alternatively, the camera pen may use a transmitter or data port to communicate data corresponding the solution in real-time to an input of a nearby workstation. The workstation may then play back the audio for the teacher, or it may display the solution on an electronic display device. Alternatively, the camera pen may transmit the solution to the printing device so that the solution key for a personalized worksheet may be printed.

As the teacher receives the solutions, the teacher marks the worksheet with evaluation marks 422, using at least some marks that the server will be able to read and interpret. In order to help the teacher to make the evaluation marks in a machine readable format, the worksheet may explicitly or impliedly indicate to the teacher how and where to make the evaluation marks. (See, e.g., the teacher annotation area 220 of FIG. 2.) For example, the teacher may be instructed to draw a particular character to indicate that a problem is correct, or a different character if the problem is incorrect. The teacher may further write or draw annotations on the worksheet, such as a “smiley,” a comment “big improvement,” etc. to provide feedback to the student and/or the student's parents. The teacher may select whether to turn on annotations so that they are later visible to the student, or limit them for teacher review, or turn them off entirely. The annotations may be provided for individual problems, for groups of problems or sections, or for the whole worksheet. This process may be repeated 424 for additional worksheets until the teacher's review is complete.

After the paper worksheets for a student is marked up by the student and by the teacher, some or all of the student's responses and the teacher's annotation data may be uploaded to the student data warehouse 426. This data may be used to identify problems that were answered correctly, problems that were answered incorrectly, etc., so that future worksheets can use the evaluation data to generate additional personalized worksheets for the student in the future. This data may be uploaded directly from the camera pen. For example, when the camera pen recognizes that the teacher is making a mark on a designated annotation area for a particular problem, it may capture data indicative of the mark and transmit that data to the student data warehouse. The data may be uploaded via wireless transmission, via a docking station that is connected to a network, or via any other means.

Alternatively, the teacher may submit the annotated worksheets to a scanner (which may be part of printer 106 in FIG. 1). The scanner scans each worksheet and generates and stores a corresponding digital file (e.g., image data, such as a .pdf or .tif file) that is associated with the corresponding student. The marked and annotated worksheets may be returned to the students for each student to take home, e.g., to show to his or her parents.

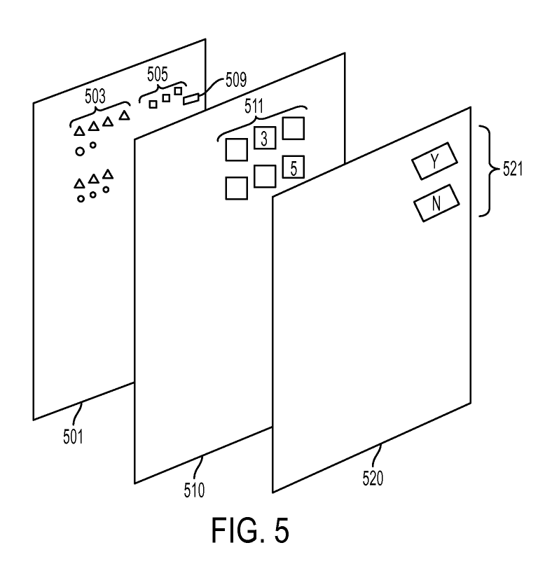

In some embodiments, any or all of the original worksheet data, the student's responses, the teacher's annotations, and the solutions may be collected and stored in the worksheet file for future reference. Alternatively, any or all of these elements may be stored as document layers in separate files, or separate data fields within individual files, so that the layers can be accessed separately or linked together later for collection and display in any desired combination. For example, as illustrated in FIG. 5, the original worksheet data layer 501 may include the problems 503, the student response indicators 505, and the teacher annotation indicators 509. A student response layer 510 may include the student's actual responses 511 as entered in the student response area on the worksheet. A student response layer 510 may include the teacher's annotations 521, such as yes/no indicators of accuracy, as entered in the teacher annotation area on the worksheet.

The evaluation data stored in the worksheet files may be used for determining how much the student has progressed in a topic area and for selecting problems for the next worksheet to be generated. The problems may be selected in accordance with the student's performance on the previous worksheet(s), the appropriate progression and difficulty level for the student, and the student's risk tolerance. Also, the problems selected for the next worksheet may be personalized with favorite items of the student.

In some embodiments, before the worksheet is printed, the evaluation data and/or the problems selected for a worksheet may be presented to the teacher at a workstation to be viewed, validated, and/or annotated. The teacher may submit suggested changes to the evaluation data via the workstation or by re-marking and resubmitting the worksheet to the server, for reevaluation. The server may update the worksheet file with one or more new problems based on the teacher's input. The teacher may also submit suggested changes to the next worksheet via the workstation.

Referring back to FIG. 3, to collect information from a completed worksheet, the processor 320 may execute any or all of a stroke lifter or smart pen capture software module 314, granular assessment evaluator software module 315, practice worksheet evaluator software module 316, and a practice worksheet generator software module 318, each of which is described further below. The stroke lifter/smart pen software module 314, worksheet evaluator software module 316 and a worksheet generator software module 318 each include a series of programmable instructions capable of being executed by the processor 320. The series of programmable instructions can be stored on a tangible computer-readable medium accessible by the processor 320, such as RAM, a hard drive, flash memory, smart card, etc., for performing the functions disclosed herein and to achieve a technical effect in accordance with the disclosure. The functions of the stroke lifter/smart pen software module 314, practice worksheet evaluator software module 316 and a practice worksheet generator software module 318 may be combined into one module or distributed among a different combination of modules and/or among different servers.

The data storage facility 304 includes at least one nonvolatile storage device for storing information that the server 302 accesses and uses for making requested recommendations. In the current example, the data storage facility 104 includes a first storage device for storing a student data warehouse 340 and a second storage device for storing worksheet repository 342. Software necessary for accessing data in the data storage facility 104, including retrieving data, manipulating data and storing data, may be included with the server 102 and/or the data storage facility 104. The server 102 and the data storage facility 104 may be configured as one component or may be configured as separate components which are in data communication with each other.

The data storage facility 104 may be a central database, a distributed database, or may include local storage associated with one or more of the components (e.g., server 102, printer 106, and workstations 110 of FIG. 1) of the worksheet generator system. The components may share information, such as worksheets, scanned worksheets, validated worksheets, evaluated worksheets and reports related to evaluations of worksheets, by storing information on and retrieving information from data storage facility 104. The method of sharing information may be done in a number of ways, such as a first component notifying a second component when a particular file is available for the second component to retrieve or process, the first component sending the file to the second component, or the second component checking the data storage facility 104 at regular intervals for files that it needs to retrieve for processing.

The student data warehouse 340 stores personal information 344 and educational information 346 associated with each student. The personal information 344 includes, for example, name, address, age, ethnicity, gender, class, teacher, hobbies, favorite personal item data, such as for specifying the student's favorite sports, music genres or musical selections, books, hobbies, and/or interests. The educational information 346 includes, for example, evaluation data; granular data, and ID codes associated with previously administered assessments; student's academic grades per semester; the student's current progression level; performance ratings per academic behavior (e.g., paying attention or complying with classroom rules); favorite educational item data; or worksheet generation preference data.

The student's current progression level may include a current progression level for each academic skill the student is being instructed and exercised in using the worksheets, and further includes a mastery level for the current progression level. The mastery level may be based on the evaluation data associated with problems recently presented to the student for the current progression level, and may be expressed, for example, as a ratio of correctly answered problems/incorrectly answered problems. The progression data may further include information such as the date when the current and/or previous progression levels were introduced to the student, a date when instruction for each of those progression levels was completed, and a mastery level achieved for each of those progression levels.

For each worksheet that was administered to the student and the results entered into the system scanned by the evaluation data associated with a student includes the processed results of evaluation marks that were made by the student. The results may be lifted from a digital file generated by a scanner that scanned the worksheet, or the results may be directly received from a smart pen or other electronic writing device. After the evaluation marks are lifted they are processed. When a stroke lifter module is used, it may receive the evaluation marks from the scanned file. When a smart pen module is used, it may receive the evaluation marks directly or indirectly from the teacher's smart pen. In the present example, the lifting and processing includes determining if a mark, such as a slash, is present or absent in a selected location of a digital file of image data. The evaluation result (correct, incorrect, needs more practice, etc.) may be generated based on the presence or absence of the mark in each location.

Alternatively, the lifted marks may be processed using Intelligent Character Recognition (ICR) to determine the meaning of the lifted marks. ICR here refers to using an intelligent version of optical character recognition for recognizing handwritten characters. The evaluation result may be generated based on what ICR indicates the teacher communicated via the teacher's evaluation marks. Alternatively, a system that uses a smart pen may provide better accuracy and faster delivery to the server than a scanned or ICR-processed system.

The evaluation result for each mark may be stored with the evaluation data. Thus, the evaluation data indicates which problems the teacher marked as correct or incorrect and any additional teacher evaluation information, such as which academic skills the student needs to practice more or which common errors the student made.

The granular data may include data describing the student's performance on previously administered assessments, as described in related U.S. patent application Ser. Nos. 12/339,979, 12/340,054, 12/340,116, and 12/640,426, which are all incorporated herein by reference.

The progression data 356 in the present example may include a plurality of progressions. The progressions may be ordered along progression paths relative to one another. Alternative progression paths may be available and selectable. For example, a progression for teaching single-digit addition may precede a progression for teaching single-digit subtraction, but a teacher may elect to reverse this order.

In the current example, each progression includes a path of at least two ordered levels. Each level (also referred to as a progression level) may have a path of ordered sub-levels. Each sub-level may further have a path of ordered sub-levels, etc. Each level or sub-level of a progression may include a family of least one problem. Problems within a family of problems are related to comparable skills and have a comparable degree of complexity. These problems are referred to as parallel problems. When a progression has multiple ordered paths of levels, the multiple ordered paths of levels may be nested. A student is assigned a current level, and in accordance with the student's evaluation data the student advances or retreats along the path on which the student's current level is located.

Each progression and level may be identified by an identification (ID) code or a descriptor (e.g., progression descriptors: math, grammar, spelling, social studies). Level descriptors for a “math” progression may include descriptions such as: add whole numbers, subtract whole numbers, add integers, subtract integers. The system also may include sub-level descriptions. For example, sub-level descriptors for the “add whole numbers” level may include: i) counting objects; ii) recognizing that groups of objects can be added together to form a larger group whose sum is the total of items in each group; iii) adding numbers 1-5; iv) counting by groups of 1s, 10s, 100s; v) adding zero or one to any number; and vi) adding numbers 0-9.

Subsequent levels along a path may represent a progression in skill or a progression in complexity using the same skill A progression in skill is demonstrated by the path along sub-levels i-vi above. A progression in complexity is demonstrated wherein sub-level vi above may have first and second sub-levels, progressively more complex. The first sub-sub-level includes all of the problems having solutions which yield a one-digit answer, and the second and more complex sub-sub level includes all of the problems having solutions which yield a two-digit answer.

The favorite educational item data may include ranked information that reflects the student's favorite or preferred and least favorite academic topics or skills. This data may be obtained from the student's own ratings of what topics the student most prefers or least prefers, or based on data gathered about the student's performance or activity level in various academic topics, such as academic skills in which the student has scored well or progressed quickly; or an academic topic on which a student has recently written a research report (such as China or spiders).

The worksheet generation preference data includes, for example, evaluation range, selection criteria, and risk tolerance data. The evaluation range includes the number of recently administered worksheets or the date range for administration of worksheets for which evaluation data will be used to select problems for a new worksheet that is being generated. The evaluation range may be selectable by the teacher, else a default value is used.

In the present example, the selection criteria may include the total number of problems to be included in the worksheet, a review ratio, a challenge ratio, and time constraints. The review ratio defines the ratio of the number of problems associated with a selectable range of levels that precede the student's current level relative to the number of problems associated with the student's current level. The challenge ratio defines the ratio of the number of problems associated with a selectable range of levels that follow the student's current level relative to the number of problems associated with the student's current level. The time constraints provide instructions to the teacher administering the worksheet if the worksheet or a portion of problems included in the worksheet are to be administered under timed conditions for exercising the student's speed and fluency.

The risk tolerance data may be used to initialize a student's current progression level per academic topic and to recalculate the student's current progression level based on evaluation data from worksheets administered to the student. The risk tolerance data may be selected by the teacher or student, default values may be used, or the data may be set based on an analysis of the student's past performance. Different risk tolerance data may be used for different academic skills, for example when a student exhibits a low frustration level for one academic skill but prefers challenge in another academic skill. Alternatively, the same risk tolerance data may be used for the student for all academic skills. In the present example the risk tolerance data may include selectable thresholds, such as those labeled herein as Init Threshold 1 and Init Threshold 2 which are used for determining an initial progression level, and those labeled herein as Advance Threshold 1 and Advance Threshold 2 for determining when and to what progression level to advance the student. The worksheet generator module 318 executes an algorithm, such as advancing algorithm (see Equation (1) below), to determine the progression level at which the student will be initialized or advanced. Other variations of risk tolerance data and algorithms that selectably adjust the rate at which the student has progressed through the progressions are possible, and the present disclosure is not limited to the risk tolerance data and advancing algorithm described herein.

Worksheet repository 342 stores, for example, worksheet data 352, problem data 354, progression data 356, and error data 358. The worksheet data 352 may include the ID code of the worksheet, ID codes of each problem included with the worksheet, ID codes of each student who was administered the worksheet, and evaluation data related to the student's overall performance on the worksheet.

The problem data 354 includes a set of problems that may be printed on a worksheet. Each problem may be stored as a data file, record or field. Associated with each problem and stored in the problem data for each problem may be any or all of the following: an ID code identifying the problem; a progression description that reflects the problem's position relative to one or more levels or sub-levels of at least one progression and identifies the progression; a presentation of the problem, namely specifying how the problem will be printed and appear on the worksheet; the correct response; ID codes of common errors associated with the problem; or common errors that may be associated with incorrect responses that a student may mark. The progression description may specify one or more progressions, levels, or sub-levels with which that the problem is associated, such as an ID code identifying the progressions or levels, or a descriptor that describes a level or sub-level and its position in a progression, e.g., math/whole numbers/addition, 0<(2 addends)<6, which describes all problems associated with adding two numbers, with each of the numbers ranging between 1-5. The error data 358 may include a set of common errors for the problem. Associated with each common error may be an ID code, a presentation of the common error (e.g., a textual description) and problem ID codes with which the common error can be associated.

The printer 106 includes a print device 322, and it may include one or more scanner devices 324, a processor 326, a user interface (UI) 328, and communication devices for communicating with the data storage facility 104, server 102, and/or client computing device such as workstation 110, either directly or via the network. The scanner device 324 of the printer 106 includes hardware and software for imaging a document and generating corresponding imaging data. Multiple scanner devices may be provided. The scanner devices 324 may be stand-alone devices or may be in communication with or one or more of the devices that are in communication with the network. Each scanner device responds to a request to scan a document by imaging the document and generating a corresponding digital file of image data. The image data may be stored locally or in a central location, e.g., in the associated student's educational information 346 of data storage facility 340, that is accessible to processor 320 of server 102. In either case, the image data is submitted to or accessible by the server 102.

The system may include one or more workstations 110. Each of the workstations is a computing device, such as personal computer, personal digital assistant, smart phone or a mobile computing device, having a processor 330 (e.g., a microprocessor or CPU); a UI 332; at least one storage device (e.g., RAM, ROM, flash memory, removable memory, etc.); and communication devices for communicating with the data storage facility 104, printer 106, and/or server 102, either directly or via the network. The UI 332 includes a user input device, such as a keyboard, keypad, touchpad, mouse, smart pen, touch screen or the equivalent, and a display device, such as indicator lights or a display screen. The UI 332 may provide a graphical user interface via which the user may enter and receive information. The processor 330 may communicate with the server 102, data storage facility 104, and/or MFD 106, for receiving input from and generating output to a user via the UI 332, and to process data for generating worksheets. The workstation 110 may further be provided with the ability to access the answer to one or more specified problems.

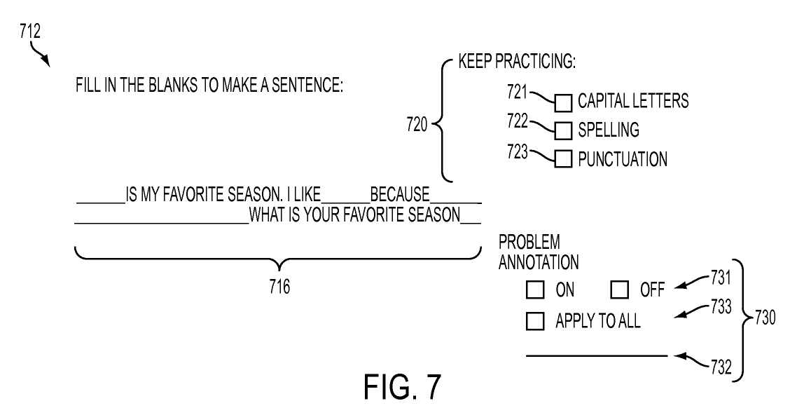

With reference to FIG. 7, an exemplary alternate worksheet 602 is shown. The exemplary worksheet 602 may be provided with machine readable identifying information 604, including a worksheet identification (ID) code 606, a student ID code 608, and a time or date stamp 610. The worksheet ID code 606 identifies the worksheet 602 so that data may be stored in association with the worksheet 602. Alternatively, embedded data such as glyph codes or a dot-matrix pattern may be printed on the worksheet. The machine readable data may be scanned by the multi-function device, interpreted by the server and stored in the data storage facility.

The worksheet 602 is provided with the presentation 616 of one or more problems 612. Each problem 612 may have associated with it an ID code, a presentation of the problem 616, a problem template, a student response area 618, and a teacher evaluation area 620. The problem's ID code may be displayed an optical code 614 adjacent to the problem 612. The ID code 614 identifies the problem 612. The ID code 614 may be an optical code, such as a barcode, or it may be an alphanumeric code. If the data storage facility 604 stores the ID code 614 of all of the problems 612 associated with the worksheet 602, then the ID codes 614 may be omitted from the worksheet 602. The problem template describes the layout requirements of the problem presentation 616 and the location relative to a predetermined reference location (such as the top left corner of the problem presentation 616) in which an evaluation area 620 is located. Additionally, the problem template includes a set of rules, described as the problem rubric, for processing the marks that are found to be present of absent in evaluation areas 620. The problem template may be associated with the problem 612 and stored in a variety of ways, such as stored in an associated separate file, record, or field or provided as associated metadata. The presentation of the problem 616 is not limited to a particular format. It may be textual, a presentation of a mathematical equation to be solved, graphical, or in another format. The presentation of the problem 616 may include explicit instructions for how to respond to the problem 612, or the instructions may be implied.

The student response area 618 provides an area for the student to mark a response to the problem 612. The format for the response area 618 and the student response is not limited and may overlap with the presentation of the problem 616. For example, the problem 612 may prompt the student to enter a response by: annotating (e.g., underlining, circling, drawing a slash through a selection, adding punctuation marks, etc.) text presented with the problem 612; selecting a choice from multiple choices; filling in a blank; matching items from two columns; drawing a picture; writing out a mathematical computation, e.g., a long-division problem; or other means. The student response area 618 is set up so that when the student enters a response in the student response area 618, a teacher can recognize the response and be able to evaluate it for correctness. The teacher may use a camera pen to identify a worksheet and coordinates of a problem on the worksheet. This data may then be used by the system to retrieve the answer to the problem that is printed on the coordinates to help the teacher evaluate the student responses. In this way, the teacher may evaluate the student's performance as the teacher walks around the room or as the student brings his or her completed individualized worksheets to the teacher at the teacher's desk.

The student response area 618 may be defined by a marking that is visible to a viewer, such as the student or the teacher. The definition of the student response area 618 merely needs to be sufficiently apparent to the student so that the student knows where to make a mark, and to the teacher so that the teacher knows where to look for it. In the example shown, for the first problem 612 the student response area 618 is visually indicated with a blank square. The student therefore knows where to make a mark to indicate the answer, and the teacher will recognize the mark as the answer.

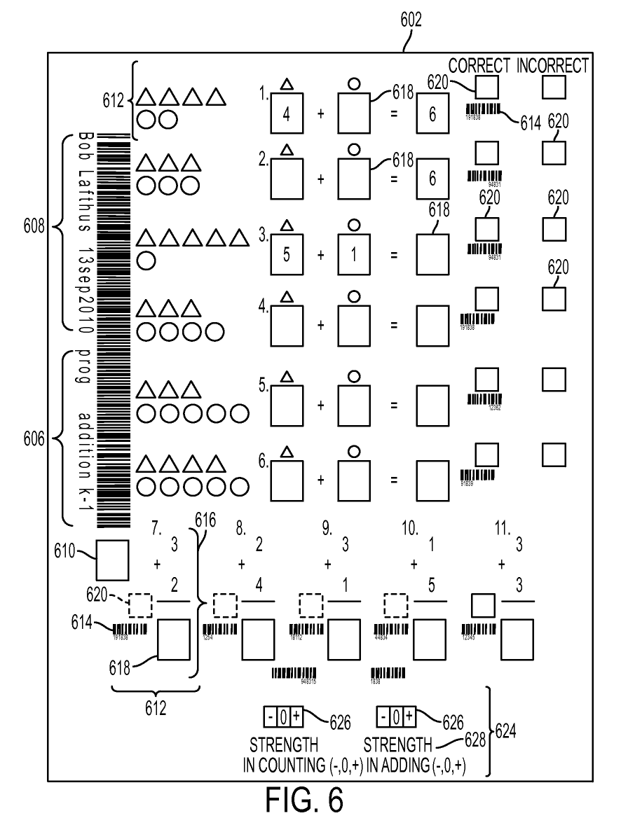

To illustrate a problem's 612 relationship to a progression and a level, in the current example, problems 1-6 of worksheet 602 shown in FIG. 6 are associated with the progression path “math/add whole numbers/level ii) recognizing that groups of objects can be added together to form a larger group whose sum is the total of items in each group.” Problems 7-11 of the same worksheet 602 are associated with the progression path “math/add whole numbers/level iii) adding numbers 1-5.”

The teacher evaluation area 620 provides a location for a teacher to evaluate a problem 612 for correctness, e.g., to mark the student response as right or wrong. In the present example, the teacher uses a camera pen to mark worksheet 602 with evaluation marks that correspond to the teacher's evaluation. The server, workstation, or a processor in the pen itself receives the teacher's marks from the camera pen and processes the teacher's marks and locates, reads, and stores the teacher's evaluation marks entered in the teacher evaluation area 620. In problems 1-6, but without limiting the disclosure thereto, the worksheet 602 is provided with specific locations for the teacher evaluation marks, where the presence or absence of a mark at the location provides evaluation information (e.g., if the problem was answered correctly or incorrectly) that is stored as evaluation data. The evaluation data is stored and associated with the student, the problem 612 and/or worksheet 602, and optionally the date or time that the worksheet 602 was created or administered. In some embodiments, evaluation marks marked within an evaluation area (such as 620) may need to be processed to determine evaluation information indicative of how the student performed on the problem. Teacher evaluation marks may be uploaded from the camera pen to the server, or they may be uploaded to the server after being scanned by a document processing device and processed using character recognition.

The teacher evaluation area 620 may include sub-areas that can be marked by the teacher to provide additional information about how the student answered the problem 612 or about the student's progress. For example, a check box may be provided for each of a variety of errors that are commonly made by students when executing the academic skill exercised in problem 612 or to indicate that the student needs more practice in a particular area. For example, if the problem 612 requires the student to solve a two or three digit multiplication problem a check box may be provided for common errors associated with this academic skill, such as a carrying error, specific digit multiplication error, digit alignment error, digit reversal error, or digit addition error. Accordingly, detection of the absence or presence of an evaluation mark, such as a slash, in these check boxes indicates which errors the student made.

Another example of a teacher evaluation area associated with an exemplary problem 712 is shown in FIG. 7. The presentation of the problem 716 includes several blank lines for the student to fill in. The teacher evaluation area 720 includes three labeled check boxes 721, 722, 723 for the teacher to mark in accordance with the teacher's evaluation. Using the check boxes 721, 722, 723, the teacher can indicate by checking one or more of the sub-evaluation areas whether the student needs to keep practicing any combination of proper use of capital letters, spelling, or punctuation. Accordingly, detection of the absence or presence of an evaluation mark, such as a slash, in these check boxes 721, 722, 723 indicates in which academic the student requires additional practice. Optionally, the teacher evaluation area or another portion of the worksheet also may include an annotation area 730 having a data entry field 732 in which the teacher may enter free-form comments, comments that meet a predetermined protocol, and/or select from a set of available annotations. The annotation area 730 also may include an activation selector 731 in which the teacher may select whether to activate or deactivate the annotation area. Optionally, the annotation area 730 also may include a scope selector in which the teacher may select whether or not to apply the command of the activation selector 731 to the entire worksheet, a single problem, and/or a group of problems or area of the worksheet.

Referring again to FIG. 6, the worksheet 602 may further include an additional teacher evaluation area 624 that can be marked by the teacher to provide additional information about how the student performed overall on the worksheet 602. A collection of evaluation areas 624 may be stored e.g., in a file, record, or field, with the problem data. The additional information may include the teacher's opinion about whether the student needs more practice with an academic skill or area, needs more or less time to complete the worksheet 602, needs to be progressed more quickly through the academic skills, shows signs of reaching a frustration level due to the quantity or complexity of the problems 612, shows signs that faster progression through the material would be beneficial, etc. Some of this information may come from observations of the student that the teacher makes while the student is doing the worksheet 602, such as if the student appears unconfident, erases frequently, appears frustrated due to difficulty, appears frustrated due to lack of challenge, does not have enough time to complete the work, completes the work well before the time limit is reached, etc.

One or more check boxes 626 or other boundary indications may be provided in the teacher evaluation area 624 that the teacher can mark. Each check box 626 may be provided with an explanation 628 that explains to the teacher what the check box 626 should be used for and how to indicate an answer. In the example provided the check boxes are used for the teacher to provide an opinion of the student's strength in the skill areas of counting and adding based on the teacher's observation of the student's behavior as the student executed the worksheet 602 and/or the teacher's evaluation of the types of mistakes that the student made. In this example, checkbox 626 includes the symbols “−,” “0,” and “+” for the teacher to select by placing a slash through the selected symbol, respectively. In the current example, the symbols “−,” “0,” and “+” indicate, respectively, that based on the teacher's observations the student needs more practice and to progress more slowly, that the student's progress rate should not be altered, or that the student should be progressed more quickly. Using a slash to indicate a selection provides for robust detection of the mark. Detection of the presence or absence of an evaluation mark, such as a slash, in these check boxes 626 indicates the student's strength in the areas of counting and adding.

Alternatively, the checkbox 626 could provide space for the teacher to write in a symbol or a comment. After extraction via the camera pen or scanning, the results may be presented to the teacher for verification. The results may be presented via the workstation, via an audio output of the camera pen, or via another device.

The evaluation area 624 includes an associated evaluation area template that describes the layout requirements of the evaluation area presentation and the location relative to a predetermined reference location in which checkboxes 626 are located. Additionally, the evaluation area template includes a set of rules, described as the evaluation rubric, for processing the marks or absence of marks in the check boxes 626. The evaluation template may be associated with the evaluation area 624 and stored in a variety of ways, such as stored in an associated separate file or field or provided as associated metadata.

The number of check boxes 626, the usage of evaluation marks extracted from the check box 626, and the different marks that may be used to indicate teacher evaluation result may vary from worksheet to worksheet. Optionally, an ID code associated with each check box 626 or evaluation area 624 may be displayed as optical code 630 adjacent to the check box 626 or evaluation area 624. Alternately or in addition, embedded data such as glyph codes or dot-matrix patterns may be printed on the form at or near the check box to identify the box's location.

The worksheet 602 may have an associated worksheet template that includes the identification code for each problem 612 and evaluation area 624 included in the worksheet 602. The template may further include a worksheet layout which describes the layout for all of the information to be printed on the worksheet 602, including the presentation of the problems 612, evaluation area 624, and identifying information 604.

When a first worksheet is administered to a student for an academic skill that will be exercised using worksheets, the teacher may determine an initial level for that academic skill. The teacher may do this by administering an initialization worksheet, for example as a survey-based worksheet that includes problems from a wide variety of levels of progression within that skill, or as a worksheet that includes problems from one level or only a few closely related levels. The teacher may evaluate the initialization worksheet and the results of the evaluation are used to determine the initial progression and level within the progression at which the student will be initialized. The student's risk tolerance data may be used together with the results of the evaluation to determine an initial progression and level.

The worksheet generator module may determine the student's initial current level for each academic skill using the advancing algorithm in Equation (1), wherein Threshold 1=Init Threshold 1 and Threshold 2=Init Threshold 2 and Init Threshold 1 and Init Threshold 2 are provided by the risk tolerance data, and the Student Performance Level (SPL) is determined by the student's performance on the initialization worksheet for each academic skill. When using the survey-based worksheet, the worksheet generator module may determine the highest level from the various levels included in the survey-based worksheet that meet the criteria of the advancing algorithm.

Referring back to FIG. 4, the method shown in FIG. 4 assumes that the student's initial progression and level were determined and that the student has since been administered at least one worksheet or otherwise a first worksheet has been selected. The method shown refers to generating a new worksheet for the student using evaluation data that has been generated for one or more previously administered worksheets.

At step 402, the worksheet generator module receives a request to generate a practice worksheet for a student for one or more requested academic skills. The request may have been generated by a teacher or student via a workstation, or it may be automatically generated based on factors such as a date or time. At step 404, the worksheet generator module retrieves the student's evaluation data from within the selected evaluation range which is stored with educational information. At step 406, the worksheet generator module retrieves the student's current progression level per requested academic skill. Additional data from the student's personal information and educational information may also be accessed and used as described further below.

At step 408, the worksheet generator module accesses the problem data. At step 410, the worksheet generator module selects for the student at least one problem from the problem data using the accessed evaluation data. The selected problems each may have an associated ID code which is associated with the ID code assigned to the worksheet being generated. The worksheet generator module determines whether to advance or retreat the student's current level based on the accessed evaluation data. In the current example, the determination may be performed using the advancing algorithm in Equation (1), wherein Threshold 1=Advance Threshold 1 and Threshold 2=Advance Threshold 2, and Advance Threshold 1 and Advance Threshold 2 are provided by the risk tolerance data. In another example, the decision of whether to advance or retreat and by how much is made by the teacher when generating a specific worksheet or in general for generating any worksheet, or automatically based on data associated with the student, such as the student's prior performance when challenged by advancing level(s), or when not advanced or having retreated one or more levels. The evaluation data may include SPL, which in the current example is the percentage of problems included in the evaluation range that are at the student's current level which the student answered correctly.

EQUATION (1)

SPL>Threshold 1→Advance student's current level to next level a.

Threshold 2>SPL>Threshold 1→Keep student's current level and use parallel problems 212 b.

SPL<Threshold 2→Retreat student's current level to previous level c.

The steps of advancing the student's level to the next level or retreating the student's current level to a previous level may include accessing the progression data, locating the student's current level in the progression data, and following the path that the current level is located along in an advancing or retreating direction or selecting parallel problems at the student's current level. Advancing the student's current level beyond the final level of the student's current progression includes advancing to the first level of the next progression, as designated by the progression data Likewise, retreating the student's current level beyond the first level of the student's current progression includes retreating to the final level of the previous progression, as designated by the progression data. When not advancing or retreating relative to the student's current level, but maintaining that level, problems parallel to previously selected problems are selected. When selecting parallel problems, only parallel problems that have not yet been presented to the student may be selected, as desired. The teacher may also designate via the risk tolerance data and based on the student's evaluation data that the student may advance or retreat by more than one level at a time, or skip progressing through the sub-levels of a level or the levels of a progression.

Additionally, the selection of problems to include in the worksheet is made based on selection criteria that are provided by the teacher. If the selection criteria are not selectable or no selection has been made, then default selection criteria are used.

Evaluation areas are also selected for inclusion in the worksheet, such as based on having an association with any of the selected problems or as specified by the teacher.

At step 412, a printer-ready worksheet file is generated that includes the selected problems. Related data is associated with the printer-ready worksheet file. The related data may be associated with the printer-ready worksheet file and stored in a variety of ways, such as stored in an associated separate file or provided as associated metadata. The related data may include, for example, the worksheet ID code; ID codes of all of the selected problems; the student's ID code; a timestamp indicating the date and/or time that the worksheet file was generated; template data including evaluation mark location data indicating the physical location on the printed substrate that the evaluation marks are expected to be located at for each problem and its associated evaluation area and for each evaluation areas and its associated check boxes, expected types of evaluation data (e.g., “√,” “−,” “0,” “+”), and the meaning associated with each of the expected types of evaluation data.

Generating the printer-ready worksheet file includes accessing the template data for each problem and each evaluation area and generating a worksheet template that describes the arrangement and layout of all of the elements to be included in the worksheet, including the selected problems. The layout may be generated using any now or hereafter known algorithm that lays out the problems, evaluation areas, and identifying information for printing in accordance with their individual layout requirements. Additionally, the problems may be laid out for ordering them in accordance with their associated progression level, with easier problems preceding harder ones. The printer-ready worksheet file includes instructions for printing the presentation of each selected problem, of each evaluation area, and each additional evaluation area.

The selected problems may include an embedded adjustable item, e.g., an adjustable textual or graphic term, which can be replaced with a selected textual or graphic interest term, respectively, in accordance with the student's favorite item data. For example, with reference to the worksheet shown in FIG. 2, the items to be counted in the problem presentation for problems A-D, are triangles and circles. The triangles and circles may be adjustable graphic terms that may be replaced by two different graphic interest terms selected from the student's favorite item data. For one student, the two different graphic interest terms may be frogs and salamanders. For another student, the two different graphic interest terms may be skis and ski boots.

The examples presented below illustrate three versions of an exercise that may be included in a problem presentation. In each of the examples A, B, and C, an adjustable textual term was replaced with a textual interest term selected from the student data associated with three different students. The textual interest terms may have been adjusted, such as for conjugation or forming a plural. A database may be accessed for words, textual terms, graphics, or other elements that are related to items, subjects, activities, etc. that are favorites of the student or are familiar to the student, such as based on the culture related to the student's ethnicity, gender, age, or demographic information.

### Example A

### Underline Nouns and Circle Verbs

The volcano erupted.

The earth shook.

Dinosaurs roared and stomped on the ground.

### Example B

### Underline Nouns and Circle Verbs

The rain stopped.

The world sparkled.

Unicorns ran and jumped over the rainbow.

### Example C

### Underline Nouns and Circle Verbs

The tree fell.

The bugs jumped.

Birds squawked and flew to the sky.

Additionally, a database of current items may be accessed for replacing an adjustable item. Such current items may include the student's current geographic location, the current season, the current or recent weather, current or recent news or sports events, or a current or recently studied academic topic.

The printer-ready worksheet file is printed. A printed copy of the worksheet is administered to the student in step 414. In step 416, the teacher evaluates the administered worksheet and uses a smart pen to mark one or more of the evaluation areas with evaluation marks in accordance with the evaluation (step 420). As the smart pen moves over a problem, the smart pen retrieves the solution to the problem (step 418) and presents the solution to the teacher (step 420).

However, in a different embodiment, the teacher evaluation areas of a worksheet may be defined by a delimiter and/or label to indicate clearly to the teacher where to make the teacher evaluation mark. The delimiter may additionally be used by a stroke lifter module or smart pen module to locate the evaluation mark, such as by optically locating the delimiter.

In one variation, the teacher may request that the worksheets be individualized for clusters of students whose evaluation data indicates a selected degree of similarity. The teacher may select how many clusters should be formed in a class of students or a maximum and/or minimum number of students to include per cluster. The problems selected for the generated worksheet are associated to a level that is as close as possible overall to the current level of the students in the cluster. A system and method for determining a degree of similarity among clusters of students within a class, and for selecting academic material that is close to the performance level of students included in the cluster are described in greater detail in related U.S. patent application Ser. Nos. 12/339,979, 12/340,054, and 12/340,116.

Some or all of the above-disclosed and other features and functions, or alternatives thereof, may be desirably combined into many other different systems or applications. Various presently unforeseen or unanticipated alternatives, modifications, variations or improvements therein may be subsequently made by those skilled in the art, each of which are also intended to be encompassed by the disclosed embodiments

1. A system for administering an individualized worksheet for a student, comprising:
a processor; and
a tangible, computer-readable memory with instructions that, when executed, cause the processor to:
select, from a problem library, a set of problems to be printed in an individualized worksheet;
generate a unique set of embedded data that, when printed on a substrate, yields a unique pattern configured to be read by an optical collection device;
generate a worksheet file for the individualized worksheet, the worksheet file containing data corresponding to a worksheet template, the selected problems, a solution to each of the selected problems, and the embedded data so that the embedded data identifies a physical position of each selected problem on the individualized worksheet;
receive captured data from the optical collection device, the captured data comprising at least some of the embedded data for the individualized worksheet;
identify, from the worksheet file, a problem from the set of problems, the problem being that which has a physical position that corresponds to the captured data;
identify a solution corresponding to the identified problem; and
generate a command to present the solution to a user of the individualized worksheet.

2. The system of claim 1, wherein:
the instructions that cause the processor to select a set of problems comprise instructions that, when executed, cause the processor to:
retrieve evaluation data corresponding to the student,
retrieve data corresponding to a topic for the individualized worksheet,
select, from the problem library for inclusion in the set of problems, a problem that corresponds to the topic and to the evaluation data, and
include the selected problem in the set of problems; and
the instructions that cause the processor to generate the worksheet file comprise instructions that, when executed, cause the processor to:
retrieve, from a worksheet data repository, a worksheet template, and
include the embedded data, the selected problem, a solution to the selected problem, and the worksheet template in the worksheet file.

3. The system of claim 1, further comprising a data warehouse that stores the worksheet data repository, the problem library, and the worksheet files.

4. The system of claim 1, further comprising a printing device configured to, upon receipt of the worksheet file, execute the file and print the individualized worksheet on a substrate.

5. The system of claim 1, further comprising a camera pen that includes the optical collection device.

6. The system of claim 5, wherein the camera pen further comprises:
a processor;
a tangible, computer-readable memory; and
a marking tip that, when placed on and moved across the worksheet under a force, will impart a mark on the worksheet.

7. The system of claim 6, wherein the camera pen further comprises:
an audio output; and
program instructions stored on the memory that, when executed in connection with receipt of the command to present the solution to the user; cause the audio output to deliver the solution via the audio output in audible form.

8. The system of claim 1 wherein the instructions, when executed, also cause the processor to:
receive a student response to the identified problem;
receive, from the user, an annotation that corresponds to the student response; and
store data corresponding to the worksheet file, the student response, and the annotation in a data warehouse so that each of the worksheet file data, student response data, and annotation data may be selectively retrieved and displayed to the user.

9. A method of administering an individualized worksheet to a student comprising:
accessing, via a processor; a tangible, computer-readable memory on which a problem library is stored, the problem library comprising a set of candidate academic practice worksheet problems;
selecting, via the processor from the problem library, a set of problems to be printed on an individualized worksheet;
generating, via the processor, a unique set of embedded data that, when printed on a substrate will yield a unique pattern configured to be read by an optical collection device; and
generating, via the processor, a worksheet file for the individualized worksheet, the worksheet file comprising data corresponding to a worksheet template, the selected problems, a solution for each of the selected problems, and the embedded data so that the embedded data identifies a physical position of each selected problem to be printed on the individualized worksheet.

10. The method of claim 9 further comprising:
receiving captured data from the optical collection device, the captured data comprising at least some of the embedded data for the individualized worksheet;
identifying, from the worksheet file, a problem from the set of problems, the problem being that which has a physical position that corresponds to the captured data;
identifying a solution corresponding to the identified problem; and
generating a command to present the solution to a user of the individualized worksheet.

11. The method of claim 9, wherein:
the selecting a set of problems comprises:
retrieving evaluation data corresponding to the student,
retrieving data corresponding to a topic for the individualized worksheet,
selecting, from the problem library for inclusion in the set of problems, a problem that corresponds to the topic and to the evaluation data, and
including the selected problem in the set of problems; and
the generating the worksheet file comprises:
retrieving, from a worksheet data repository, a worksheet template, and
including the embedded data, the selected problem, a solution to the selected problem, and the worksheet template in the worksheet file.

12. The method of claim 9, further comprising:
receiving, by a printer, the worksheet file; and
executing, by the printer, the worksheet file to yield a printed individualized worksheet that includes the set of problems and the embedded data on a substrate.

13. The method of claim 12, wherein the embedded data printed on the substrate comprises a skewed dot matrix pattern or a pattern of glyph codes.

14. The method of claim 10, wherein:
the optical collection device comprises a camera pen;
the camera pen comprises a processor, a tangible computer-readable memory, a marking tip, and an audio output; and
the method further comprises implementing the command by causing the audio output to deliver the solution via the audio output in audible form as the camera pen receives input, wherein the input comprises a portion of the printed embedded data that corresponds to the identified problem.

15. A system for administering an individualized worksheet to a student, comprising:
a processor; and
a tangible, computer-readable memory with instructions that, when executed, cause the processor to:
select, from a problem library, a set of problems to be printed in an individualized worksheet,
generate a unique set of embedded data that, when printed on a substrate yields a unique pattern configured to be read by an optical collection device and used by device to identify the substrate and a location on the substrate,
generate a worksheet file for the individualized worksheet, the worksheet file containing data corresponding to a worksheet template, the selected problems, a solution to each of the selected problems, and the embedded data so that the embedded data identifies a physical position of each selected problem on the individualized worksheet,
receive captured data from an optical input device, the captured data comprising at least some of the embedded data for the individualized worksheet,
identify, from the worksheet file, a problem from the set of problems, the problem being that which has a physical position that corresponds to the captured data,
identify a solution corresponding to the identified problem,
generate a command to present the solution to a user of the individualized worksheet, and
a data warehouse that stores the worksheet data repository, the problem library, and the worksheet files; and
a printing device configured to, upon receipt of the worksheet file, execute the file and print the individualized worksheet on a substrate.

16. The system of claim 15, further comprising a camera pen that comprises:
a processor;
a marking tip that, when placed on and moved across the worksheet under a force, will impart a mark on the worksheet; and
the optical collection device.

17. The system of claim 16, wherein the camera pen further comprises:
an audio output;
a memory; and
program instructions stored on the camera pen memory that, when executed in connection with receipt of the command to present the solution to the user; cause the audio output to deliver the solution via the audio output in audible form.

18. The system of claim 15 wherein the instructions, when executed, also cause the processor to:
identify a student response to the identified problem;
receive, from the user, an annotation that corresponds to the student response; and
store data corresponding the worksheet file, the student response, and the annotation in a data warehouse so that each of the worksheet file data, student response data, and annotation data may be selectively retrieved and displayed to the user.

19. The system of claim 18, further comprising:
a camera pen having:
a processor,
a marking tip that, when placed on and moved across the worksheet under a force, generates the annotation, and
the optical collection device.

20. The system of claim 19, wherein the camera pen further comprises:
an audio output;
a memory; and
program instructions stored on the camera pen memory that, when executed in connection with receipt of the command to present the solution to the user; cause the audio output to deliver the solution via the audio output in audible form.

21. The system of claim 19, further comprising a workstation having an electronic display, and wherein the instructions in the memory, when executed, also cause the processor to transmit the command to the workstation to display the solution on the electronic display device.
